(19) United States
(12) Patent Application Publication
(10) Pub. No.: US 2025/0088907 A1
(43) Pub. Date: Mar. 13, 2025

(54) Systems and Methods for Enforcing Access Traffic Steering, Switching, and Splitting (ATSSS) Functionality in the IP Layer

(71) Applicant: MITRE Corporation, McLean, VA (US)

(72) Inventors: Ing-Wher Chen, McLean, VA (US); Shukri Abdallah, McLean, VA (US); Feng Xie, McLean, VA (US); Venkatesh Ramaswamy, McLean, VA (US)

(21) Appl. No.: 18/367,831

(22) Filed: Sep. 13, 2023

(51) Int. Cl. H04W 28/08; H04L 45/24; H04L 47/20; H04W 40/24

(52) U.S. Cl. CPC H04W 28/0925; H04L 45/24; H04L 47/20; H04W 40/248

(57) ABSTRACT

A technique is described for enforcing Access Traffic Steering, Switching, and Splitting (ATSSS) functionality using Layer 3 of the OSI model for interfacing devices having both 3GPP and non-3GPP connectivity to a 3GPP network. The technique determines whether to use the 3GPP connectivity, the non-3GPP connectivity, or both to route traffic to destinations of interest. The technique also enforces the treatment of the traffic as specified by the ATSSS policies. The technique uses IP routes, Iptables, and IP policy rules that are made available by implementations of Layer 3 of the OSI model.

### GOVERNMENT LICENSE RIGHTS

This invention was made with government support under W56KGU-18-D-0004 awarded by the U.S. Department of Defense. The government has certain rights in the invention.

### TECHNICAL FIELD

The present application pertains to systems and methods for enforcing Access Traffic Steering, Switching, Splitting (ATSSS) functionality for interfacing devices having both 3GPP and non-3GPP connectivity to a 3GPP network, such as a 5G Core Network.

### BACKGROUND

The 3rd Generation Partnership Project (3GPP) Release 15 specification governs 5G cellular network standards. The main principles underlying the 5G architecture pertain to separation of control and data plane functions, and provision of a service-based architecture. 3GPP Release 15 redefines the interface that User Equipment (UE) employs to connect and register with a 5G Core Network to use a common interface, identifying the interface as N1. A UE can employ this N1 interface over any radio network, using both 3GPP waveforms and non-3GPP waveforms (e.g., IEEE 802.11 WiFi) to connect to and register with a 5G Core Network. A UE also employs a second common interface, N3, to establish a Protocol Data Unit (PDU) session for data traffic.

As illustrated in FIG. 1, it is understood that Release 15 introduces inter-working network functions to enable trusted and untrusted access for a UE capable of Non-Access Stratum (NAS) signaling and a UE incapable of NAS signaling. For a UE that is incapable of NAS signaling to connect to the 5G network, a proxy function that can perform NAS signaling is needed. Each of these categories represents a particular network deployment. For example, the Non-3GPP Inter-Working Function (N3IWF) provided in the specification is intended to enable untrusted Wi-Fi or other access to a cellular service provider's 5G Core Network. An example of untrusted Wi-Fi access is an airport Wi-Fi network that is independent of any cellular service provider. Despite having different associated network functions, the 5G architecture remains the same.

With multiple radio networks converging on a 5G Core Network, where some use 3GPP waveforms while others do not, Release 15 also introduces a protocol referred to as Access Traffic Steering, Switching, and Splitting (ATSSS) to improve data traffic performance and redundancy. ATSSS allows the 5G Core Network to manage uplink and downlink traffic through multiple paths when the UE has both 3GPP and non-3GPP connectivity to a 5G Core Network through multiple radio networks.

Release 15 describes objectives for ATSSS for purposes of standardization but does not provide its implementation. The 3GPP standard recommends configuring ATSSS to be implemented in Layer 4 of the OSI model but that is not mandated for compliance with the standard. Multi-Protocol TCP (MPTCP) is an example of such a recommendation.

### SUMMARY

The following describes a method for enforcing Access Traffic Steering, Switching, and Splitting (ATSSS) functionality using Layer 3 of the OSI model for interfacing devices having both 3GPP and non-3GPP connectivity to a 3GPP network. The technique enforces ATSSS policies that determine whether to use the 3GPP connectivity, the non-3GPP connectivity, or both to route traffic to destinations of interest. The method also enforces the treatment of the traffic as specified by the ATSSS policies. The method uses IP routes, IP tables, and IP policy rules that are made available by implementations of Layer 3 of the OSI model.

Accordingly, a method is disclosed for enforcing Access Traffic Steering, Switching, and Splitting (ATSSS) functionality using Layer 3 of the OSI model for interfacing devices having both 3GPP and non-3GPP connectivity to a 3GPP network. IP routes are added to a destination of interest based on 3GPP connectivity and non-3GPP connectivity. Conditions are then established that are to be determined by an ATSSS engine, according to a policy for determining the route or routes and the treatment of the traffic to be delivered.

The following also discloses a storage medium storing instructions that when executed by a device cause the device to enforce Access Traffic Steering, Switching, and Splitting (ATSSS) functionality using Layer 3 of the OSI model for interfacing devices having both 3GPP and non-3GPP connectivity to a 3GPP network. This is accomplished by adding IP routes to the destination based on 3GPP connectivity and non-3GPP connectivity; and then by establishing conditions to be determined by an ATSSS engine according to a policy for determining the route or routes and the treatment of the traffic to be delivered.

### BRIEF DESCRIPTION OF THE DRAWINGS

Embodiments of the present disclosure will be described with reference to the accompanying drawings, in which:

FIG. 1 is a block diagram illustrating a known plurality of categories representing a network deployment as provided by 3GPP Release 15 specification for 3GPP access and non-3GPP access that can be trusted or untrusted.

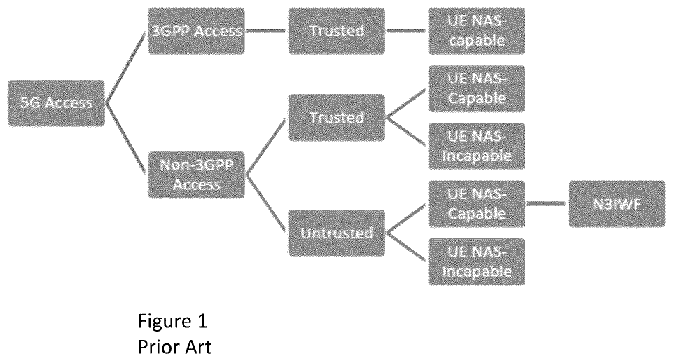

FIG. 2 is a high-level block schematic platform 200 including a UE capable of 3GPP and non-3GPP radio access for implementing ATSSS in the IP layer, in accordance with embodiments of the present disclosure.

FIG. 3 is a block diagram illustrating components of a UE and the 5G Core Network configured for non-3GPP connectivity, in accordance with embodiments of the present disclosure.

FIG. 4 is a block diagram illustrating components of a UE and the 5G Core Network configured for both 3GPP connectivity and non-3GPP connectivity, in accordance with embodiments of the present disclosure.

FIG. 5 is a table illustrating mechanisms for implementing the switching, splitting, and steering modes of ATSSS in the IP layer, using Linux commands.

### DETAILED DESCRIPTION

The present disclosure enables User Equipment (UE) with both 3GPP capability and, non-3GPP capability through multiple radio networks, to communicate more efficiently over a 3GPP core network (e.g., a 5G Core Network) by having the 3GPP core network use ATSSS to manage uplink and downlink traffic. The disclosure provides a novel and advantageous implementation for enforcing ATSSS policies.

ATSSS is an optional feature for a UE and the 5G Core Network. It provides for multi-access “PDU Sessions,” where “PDU” stands for Packet Data Unit and a “PDU Session Establishment” is the process of establishing a data path between the UE and the 5G Core network to access a data network like the Internet. In a multi-access PDU Session, data traffic can be transmitted over one or more concurrent accesses, namely, 3GPP access, trusted non-3GPP access, and untrusted non-3GPP access.

ATSSS provides modes for three behaviors-Switching, Splitting, and Steering. Characteristics for each of these nodes are described below in turn.

Switching, also referred to as Active-Standby, is for migrating all packets of an ongoing data flow from one access network to another, where only one access network is in use at a time, but the mode still ensures session continuity. In Active Standby mode, the UE will utilize only the active access network when it is available, and whenever the active radio link becomes unavailable, the user traffic switches to the standby radio link to ensure session continuity. This can enable seamless handover of the UE's control and data traffic from a 3GPP connectivity to a non-3GPP connectivity and vice versa. For Active Standby, one access network (5G or WiFi) is the active or default access network and the traffic is routed over this access network until it becomes unavailable. At that point traffic switches over to the other access network. The traffic is switched back once the active access network is available again.

Steering is for selecting an access network for a new data flow and transferring the traffic of that data flow over the selected access network. Steering is used to enable the best network selection from a choice of at least two possible communication networks. For example, steering can be used to choose between communicating over 5G or WiFi.

Splitting is for forwarding the packets of a data flow across multiple access networks simultaneously A custom hash function is used to identify specific flows and to split the packets of the identified flow based on the policy being enforced among the different routes. The custom hash function can for example split the traffic of one flow in such a manner that 30% of the traffic flows on one path and the remaining 70% of the traffic flows on another path.

ATSSS as a feature consists of three components: (i) policies to govern traffic forwarding among the multiple paths; (ii) performance measurements to detect link utilization, network congestion, and packet drops; and (iii) enforcement mechanisms to enforce the traffic policies based on network conditions.

Release 16, or Phase 1, provides that ATSSS can use Multi-Path TCP (MPTCP) to forward traffic over either one or two radio links simultaneously. MPTCP aims at allowing a Transmission Control Protocol (TCP) connection to use multiple paths to maximize throughput and increase redundancy and can aggregate the bandwidth of different networks. MPTCP is an ATSSS enforcement mechanism implemented at the Transport Layer of the OSI Model (Layer 4). MPTCP, as an enforcement mechanism, deals with TCP traffic only and does not provide a solution to UDP traffic or best effort IP traffic. A MPTCP solution requires MPTCP implementations to be present within the UE and the 5G core. A MPTCP implementation is different than the more dominant and available TCP implementations.

Release 17, or Phase 2 describes that ATSSS will also support use of other transport protocols, such as QUIC, to forward data traffic over one or two radio links simultaneously. QUIC is a general-purpose transport layer network protocol that establishes several multiplexed connections between two endpoints using User Datagram Protocol (UDP) and is designed to obsolete TCP at the transport layer. Any aspiration of having QUIC replace TCP will take a very long time because a plethora of TCP based applications would need to be rewritten. In contrast, an IP based solution as presented in this disclosure does not require application rewrite because the solution is implemented as a lower layer.

Rather than using MPTCP or QUIC, the present disclosure pertains to implementing support for Switching, Splitting, and Steering at the Network Layer of the OSI Model (Third Layer). The Network Layer is where the Internet Protocol (IP) resides. IP is the standard for routing packets across interconnected networks. According to this protocol, each IP packet has an IP source address and an IP destination address. An IP packet also has a Type of Service field that enables control over how the packet will be treated when transmitted. The present disclosure handles TCP, UDP, and best effort IP traffic.

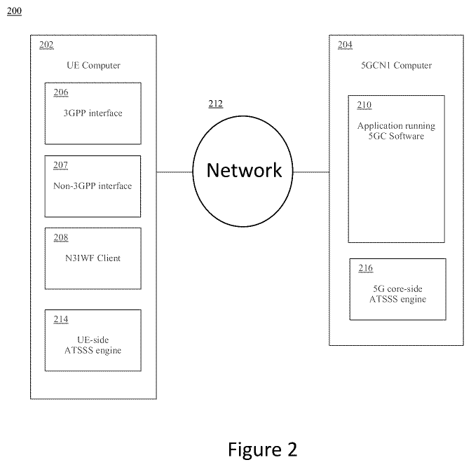

FIG. 2 is a high-level block schematic platform 200 including a UE capable of 3GPP and non-3GPP radio access for implementing ATSSS in the IP layer. In this example, two computers running Linux operating systems are in communication via network 212, with one computer 202 acting as a UE with a 3GPP interface 206 and a non-3GPP interface 207 and the other 204 acting as a 5G Core Network (5GCN1). For non-3GPP access, the UE 202 can utilize an open-source NAS signaling client 208 (e.g., https://github.com/fasferraz/NWu-Non3GPP-5GC) to enable the UE 202 to connect to the 5GCN1 204 using the software 208 over the non-3GPP interface (not drawn). The 5GCN1 204 can utilize open-source 5GC software 210 to provide 5G Core Network functionality (e.g., https://www.free5qc.org/). ATSSS policies for the downlink are enforced by ATSSS engine 216 in 5GCN1 204 and the ATSSS policies for the uplink are enforced by ATSSS engine 214 in UE 202.

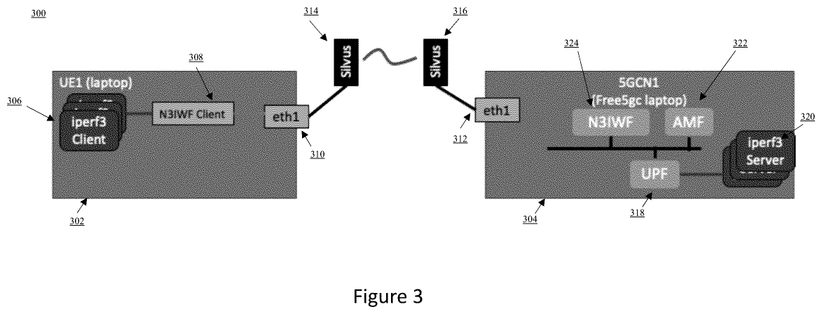

FIG. 3 illustrates a block diagram 300 of two computers that have non-3GPP access network connectivity and are configured to evaluate the connectivity. Computer 302, representing UE1, has a network connection via an ethernet port 310 to a Silvus network radio 314. Computer 304, representing 5GCN1, also has a network connection via an ethernet port 312 to a Silvus network radio 316. The Silvus network radios can be Silvus SC4240-235-BB radios connecting UE1 and 5GCN1. In this embodiment, the Silvus radios act as a Layer-2 network to deliver IP traffic flowing from UE1 (5GCN1) to 5GCN1 (UE1) respectively.

As can be seen in FIG. 3, UE1 302 includes N3IWF Client 308 for configuring a data path for non-3GPP communications, in which N3IWF Client 308 iuses the ethernet port (eth1) 310 to communicate over the Silvus radio. Computer 304 includes N3IWF network function 324 as part of the control plane of the 5G Core to provide a bridge between the untrusted non-3GPP network and the 5G Core. N3IWF has an N2 connection with Access and Mobility Management Function (AMF) 322 and an N3 connection with User Plane Function (UPF) 318.

In computer 302, iperf3 Clients 306, are used to determine the throughput for the communication. Similarly, in 5GCN1 computer 304, UPF 318 provides a path to iperf3 Servers 320. Iperf3 is a network testing tool consisting of clients and servers to measure the throughput (test speed and bandwidth) and to benchmark the links used in data communication. Iperf3 is an open-source software written in the C programming language that can run on Linux (as well as Unix and Windows).

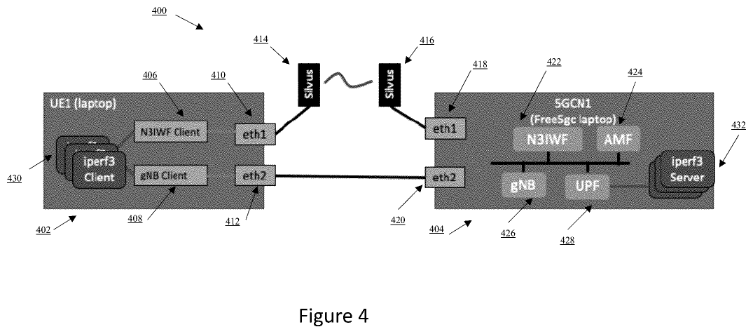

Iperf3 can be used to confirm successful non-3GPP connections between UE1 and 5GCN1. As shown in FIG. 3, there are three iperf3 clients on UE1 and three iperf3 servers on 5GCN1, such that the iperf3 clients on UE1 each establishes one TCP connection with a corresponding iperf3 server on 5GCN1. Three pairs of iperf3<Client, server>, establishing three respective TCP flows, can demonstrate the functionality of all three modes of the IP-Layer solution for ATSSS, namely, steering, splitting, and switching once a 3GPP path is added to the topology as shown in FIG. 4.

FIG. 4 is a block diagram illustrating an emulated 3GPP connection added to the setup in FIG. 3. This setup can use the open-source UERANSIM software (GitHub-aligungr/UERANSIM. Open source 5G UE and RAN (gNodeB) implementation.) to emulate a 5G radio Link. (EURANSIM is a known 5G UE and RAN (gNodeB) simulator.) UERANSIM consists of two packages: one for emulating a 3GPP capable UE and another to emulate the gNodeB that connects a 3GPP capable UE to a 5G core. The gNB Client program 408, called “nr-ue” in UERANSIM, runs on UE1 402 and performs 3GPP signaling necessary to connect a 3GPP capable UE to the gNB 426. The gNB 426 called “nr-gnb” in UERANSIM, runs on 5GCN1 404. The arrangement depicted in FIG. 4 ensures that the UE1 laptop performs 5G UE signaling using gNB Client 408 to connect to the gNB 426 using the Ethernet interfaces eth2 412 and 420. An Ethernet cable was used to emulate the 3GPP signaling because 3GPP over the air communications are not allowed. The gNB 426 upon receiving signaling requests from the gNB Client communicates with the 5G core network functions AMF 424 and the UPF 428 to establish a data path from the iperf3 Clients 430 to the iperf3 servers 432. Thus, FIG. 4 shows segments of two paths from the iperf3 clients 430 to the iperf3 Servers 432: one over the Silvus radios 414 to 416 and another over the eth2 interfaces 412 and 420. The path from the iperf3 Clients to the iperf3 Servers is referred to as the uplink and the path from the iperf3 Servers to the iperf3 Clients is referred to as the downlink.

Using the arrangement in FIG. 4, iperf3 in FIG. 4 can be used to demonstrate successful 3GPP connection between UE1 402 and 5GCN1 404. The iperf3 Clients 430 on UE1 establish three TCP connections with the iperf3 Servers 432 on 5GCN1. Using the methods proposed in this disclosure, by managing the IP routes, iptables, and IP rules in UE1's route tables the data traffic will flow through only the 3GPP radio link, the non-3GPP link, or a combination of both in the uplink direction. Similarly, using the methods proposed in this disclosure, by managing the IP routes, Iptables, and IP rules in the 5GCN1 route tables, the traffic will be routed to flow in the downlink direction.

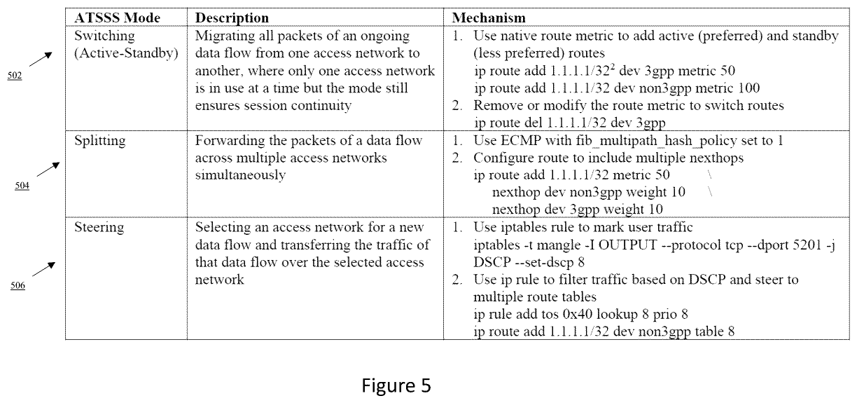

FIG. 5 is a table summarizing IP forwarding capabilities to provide ATSSS-like behaviors (i.e., Switching, Splitting, and Steering). ATSSS allows a 5G service provider to configure a policy engine running in the 5G core to specify how traffic is to flow on the uplink and downlink using one or more connections. The present disclosure uses IP forwarding capabilities as a specific way to implement the enforcement of the ATSSS policy. Enforcement of the policy means how to make the traffic go out either to or from the 5G core in a particular way. Using IP forwarding capabilities is a way to enforce a policy that is different from what is suggested in the 3GPP specification. Put another way, the present disclosure provides a Layer 3 mechanism to enforce ATSSS policies that does not require using multipath TCP or other Layer 4 solutions as suggested in the 3GPP specifications.

The advantages of an IP layer solution are: the solution is stateless and does not maintain state per flow; the solution supports UDP, TCP, and best effort IP traffic; and the solution does not require a client/server connection as is the case in MPTCP. By providing a solution at Layer 3, the designer does not need to account for what protocols are being used at Layer 4.

FIG. 5 provides an example for enforcing a policy with a mechanism using existing Linux commands. The key is that each IP route has a preference (metric) associated with it. When traffic is forwarded, a route table lookup selects the preferred route among many routes to the same destination based on the lowest metric value associated with each route.

The first ATSSS mode, switching, is also referred to as “active-standby.” In this mode, the active route and the standby route are both configured in an IP route table with the active route having the lowest preference. This mode is for migrating all packets of an ongoing data flow from one access network (the active route) to another (the standby route), where only one access network is in use at a time, but the mode still ensures session continuity. In accordance with disclosed embodiments, the first part of the mechanism for switching 502 provided in FIG. 5 states:
1. Use route metric to add active (preferred) and standby (less preferred) routes.
ip route add 1.1.1.1/32 dev 3gpp metric 50
ip route add 1.1.1.1/32 dev non3gpp metric 100

The second part is as follows:
2. Remove or modify the route metric to switch routes
ip route del 1.1.1/32 dev 3gpp

The first part is to use the native route metric to add the active and the standby routes with the active route having a lower preference value of 50. The second part is to remove or modify the route metric to switch routes from active to standby.

An IP route shows how to reach a destination by specifying an egress interface on which to send the traffic. “1.1.1.1/32” is a destination address, and to get to that address, the communication can go through the eth1 or the eth2 (as shown in FIG. 4). In part 1 of the mechanism, two routes are “added”: the active preferred route (metric 50) is added over the 3GPP eth2 interfaces 412 to 420 and the standby route (metric 100) is added over the interfaces eth1 410 to 418 leading to the Silvus radios 414 to 416 respectively. The operating system, Linux in this example, can act as a router by choosing a route with an egress interface based on the lowest metric. In the case where there are two ways to reach a destination, where the destination IP address is 1.1.1.1/32, the selection is made according to the lower metric. For example, a lower metric might correspond with higher bandwidth or lower latency, etc.

If the preferred route is deleted by the enforcement mechanism due to policy changes or interface becoming inoperable, then the traffic will flow on the standby route automatically without any packet loss.

If the old active route to the same destination reappears with a metric lower than 100, then the traffic will switch back to the original active route.

In FIG. 4, when the UE or core-side ATSSS engine enforces a switching operation during an ongoing data flow, the communication will switch between a non-3GPP connection that is being communicated via eth1 410/418 and a 3GPP connection that is being communicated via eth2 412/420. Pursuant to the mechanism for ATSSS switching 502 in FIG. 5, the preferred route is the 3GPP connection using the gNB (with metric 50) via eth2. When the communication is over non-3GPP, it uses N3IWF 406/422. This is an example of switching on the uplink. Downlink switching works in a similar way, but the configuration happens in the 5G core routing tables. Uplink and downlink do not have to switch at the same time unless an interface on the UE side or on the 5G core side or on both become inoperable.

Referring to FIG. 5, the second ATSSS mode, splitting, is for forwarding the packets of a data flow across multiple networks simultaneously. In accordance with disclosed embodiments, the mechanism for switching 504 provided in FIG. 5 states:
1. Use ECMP with fib_multipath_hash_policy set to 1
2. Configure route to include multiple nexthops
ip route add 1.1.1.1/32 metric 50
   nexthop dev non3gpp weight 10\
   nexthop dev 3gpp weight 10\

In the first part of the mechanism, “ECMP” refers to equal cost multi path. The example uses ECMP because there are two routes to the same destination “1.1.1.1/32”. Setting the variable “fib_multipath_hash_policy” to “1” in the file/proc/sys/net/ipv4 instructs Linux on which hash function to use to split the traffic among the two paths. A value of “1” means to use the values in the IP header (Layer 3) and the TCP/UDP headers (Layer 4) in the distribution of the traffic among the paths. The valid values are in the range “0” to “3” where “3” implies use a custom hash function.

For the second part of the mechanism, a route to destination “1.1.1.1/32” is specified with two equal nexthops towards the destination, where each nexthop is reachable via a different egress interface. The “dev” keyword specifies the egress interface. Specifying the two nexthops to the same destination with one metric value indicates that these two nexthop are of equal preference and traffic must be split among them. Each nexthop has a corresponding weight associated with it. Giving both nexthop an equal weight value of “10” informs Linux to not prefer one nexthop over the other and to split the traffic equally among them.

The final mode for ATSSS is steering 506 as indicated in FIG. 5. This pertains to selecting an access network for a new data flow and transferring the traffic of that data flow over the selected access network. In accordance with disclosed embodiments, the mechanism for steering can be as follows:
1. Use iptables rule to mark user traffic
   Iptables—t mangle—I OUTPUT—protocol tcp—dport 5201-j
   DSCP—set—dscp 8
2. Use ip rule to filter traffic based on DSCP and steer to multiple route tables
   ip rule add tos 0×40 lookup 8 prio 8
   ip route add 1.1.1.1/32 dev non3gpp table 8

For steering, the present disclosure uses IP tables as another Linux tool to enforce certain behaviors. The IP tables provide methods for detecting specific incoming flows and applying specific actions onto these flows. Each IP policy has a match clause and an action clause. The match clause is used to detect a specific flow by matching the values of the fields in the flow's IP header and TCP/UDP headers. If there is a match, then the actions specified in the IP policy action clause will be applied to the flow. In part 1, the matching clause identifies TCP flows destined to TCP destination port of 5201. The action clause sets the DSCP code point to 8 that is converted in the IP header field called “TOS” to the hexadecimal value of “0×40”.

For steering, the present disclosure also uses IP rules as another Linux tool to enforce certain behaviors. The second part of the mechanism uses an “ip rule.” The ip rule matches the IP traffic with the field “TOS” having a value of “0×40” and forwards it using the routes in the ip route table numbered 8 that includes a route to destination “1.1.1.1/32” over the interfaces eth1 from 414 to 416. In this example, the TCP flow destinated to destination address 1.1.1.1/32 and destination port 5201 is steered over the non-3GPP route towards the iperf3 Servers.

In summary, ATSSS has three parts: policy, measurements, and enforcement. The present disclosure does not change the policies or the measurements. Rather, the present disclosure provides a technique for enforcement, implemented at Layer 3 of the OSI Model. At Layer 3, the tools that are available are (1) routes in different ip routing tables. Each route has a metric and one or more nexthops. Each nexthop has a weight indicating its treatment value. (2) the IPtables and (3) IP rules for matching traffic flows and applying specific actions on these flows. While it may also be possible to implement the ATSSS enforcement at other layers, such as Layer 1, Layer 2, Layer 4, or Layer 7 in the ISO stack, the present disclosure implements ATSSS in the IP or Network Layer (Layer 3) by using the mechanisms available through Linux.

While the 3GPP standard suggests using layer 4, that is an MPTCP solution, and if the core does not have MPTCP support, then proxies are needed. MPTCP is a client/server pair, in which an MPTCP client can only connect to an MPTCP server. Regular TCP client only connects to regular TCP server. If the server does not support MPTCP then a proxy would be necessary.

Also, a layer 4 implementation only provides a solution for TCP traffic. It does not provide a solution to UDP traffic. Although a solution for other types of traffic for Layer 4 may be developed, that still will require multiple solutions for different traffic types. In contrast, a Layer 3 implementation provides a solution for all traffic types.

It will be appreciated by those skilled in the art that changes could be made to the embodiments described above without departing from the broad inventive concept thereof. It is understood, therefore, that the invention disclosed herein is not limited to the particular embodiments disclosed and is intended to cover modifications within the spirit and scope of the present invention.

This written description describes exemplary embodiments of the invention, but other variations fall within scope of the disclosure. For example, the systems and methods may include and utilize data signals conveyed via networks (e.g., local area network, wide area network, internet, combinations thereof, etc.), fiber optic medium, carrier waves, wireless networks, etc. for communication with one or more data processing devices. The data signals can carry any or all the data disclosed herein that is provided to or from a device.

The methods and systems described herein may be implemented on many different types of processing devices by program code comprising program instructions that are executable by the device processing system. The software program instructions may include source code, object code, machine code, or any other stored data that is operable to cause a processing system to perform the methods and operations described herein. Any suitable computer languages may be used such as C, C++, Java, etc., as will be appreciated by those skilled in the art. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, Flash memory, flat files, databases, programming data structures, programming variables, IF-THEN (or similar type) statement constructs, etc.). It is noted that data structures describe formats for use in organizing and storing data in databases, programs, memory, or other non-transitory computer-readable media for use by a computer program.

The computer components, software modules, functions, data stores and data structures described herein may be connected directly or indirectly to each other to allow the flow of data needed for their operations. It is also noted that a module or processor includes but is not limited to a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. In particular embodiments, a non-transitory computer- or machine-readable medium may be encoded with instructions in the form of machine instructions, hypertext markup language-based instructions, or other applicable instructions to cause one or more data processors to perform operations. As used herein, the term “machine-readable medium” (or “computer-readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random-access memory associated with one or more physical processor cores.

As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

In the descriptions above and in the claims, phrases such as “at least one of” or “one or more of” may occur followed by a conjunctive list of elements or features. The term “and/or” may also occur in a list of two or more elements or features. Unless otherwise Implicitly or Explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in methods, systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. Further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

We claim:

1. A method for enforcing Access Traffic Steering, Switching, and Splitting (ATSSS) functionality using Layer 3 of the OSI model for interfacing devices having both 3GPP and non-3GPP connectivity to a 3GPP network, comprising:
adding IP routes to a destination of interest based on 3GPP connectivity and non-3GPP connectivity; and
establishing conditions to be determined by an ATSSS engine according to a policy for determining the route or routes and the treatment of the traffic to be delivered.

2. The method according to claim 1, wherein the policy is enforced in the ATSSS engine using Linux commands.

3. The method according to claim 2, wherein the Linux commands are configured to add, delete, or modify IP routes in one or more routing IP tables and manage route attributes present in different routing tables.

4. The method according to claim 3, wherein a Linux command includes a route metric providing a value indicating a preference for using a route, and wherein a lower value indicates a higher preference.

5. The method according to claim 3,
wherein a Linux command includes a route nexthop indicating a next router on a path towards a destination, and if a route has more than one nexthop,
a weight indicates a distribution of traffic among the nexthop, and
a distribution function distributes packets among nexthops of a route based on weights of each nexthop, and
wherein two nexthops with equal weights result in traffic being equally routed between the nexthops.

6. The method according to claim 1, wherein the condition is implemented as a plurality of IP rules that enforce ATSSS policies by matching traffic on its attributes and applying the ATSSS policies on the matched traffic using appropriately-configured IP routes.

7. The method according to claim 6, wherein the traffic matching can be performed on IP, TCP, or UDP header fields using source and destination IP addresses, a Protocol Field, DSCP code points, and TCP/UDP source and destination ports.

8. The method according to claim 1, further comprising, for the switching mode of ATSSS, configuring an active route and a standby route by adding IP routes for a 3GPP route and a non-3GPP route, wherein a metric value is assigned a value for each route.

9. The method according to claim 1, further comprising, for the splitting mode of ATSSS, deploying a custom hash function and configuring the route to include multiple nexthops, wherein each nexthop is assigned a weight value, and wherein the custom hash function splits packets of a matched flow among different available paths based on the ATSSS policy.

10. The method according to claim 1, further comprising, for the steering mode of ATSSS, using IP tables to mark user traffic and using IP rules to filter traffic based on DSCP and steer to multiple route tables.

11. A storage medium storing instructions that when executed by a device cause the device to enforce Access Traffic Steering, Switching, and Splitting (ATSSS) functionality using Layer 3 of the OSI model for interfacing devices having both 3GPP and non-3GPP connectivity to a 3GPP network, by:
adding IP routes to a destination of interest based on 3GPP connectivity and non-3GPP connectivity; and
establishing conditions to be determined by an ATSSS engine according to a policy for determining the route or routes and the treatment of the traffic to be delivered.

12. The storage medium according to claim 11, wherein the policy is enforced in the ATSSS engine using Linux commands.

13. The storage medium according to claim 12, wherein the Linux commands are configured to add, delete, or modify IP routes in one or more routing IP tables and manage route attributes present in different routing tables.

14. The storage medium according to claim 13, wherein a Linux command includes a route metric providing a value indicating a preference for using a route, and wherein a lower value indicates a higher preference.

15. The storage medium according to claim 13,
wherein a Linux command includes a route nexthop indicating a next router on a path towards a destination, and if a route has more than one nexthop,
a weight indicates a distribution of traffic among the nexthop, and
a distribution function distributes packets among nexthops of a route based on weights of each nexthop, and
wherein two nexthops with equal weights result in traffic being equally routed between the nexthops.

16. The storage medium according to claim 11, wherein the condition is implemented as a plurality of IP rules that enforce ATSSS policies by matching traffic on its attributes and applying the ATSSS policies on the matched traffic using appropriately-configured IP routes.

17. The storage medium according to claim 16, wherein the traffic matching can be performed on IP, TCP, or UDP header fields using source and destination IP addresses, a Protocol Field, DSCP code points, and TCP/UDP source and destination ports.

18. The storage medium according to claim 11, further comprising, for the switching mode of ATSSS, configuring an active route and a standby route by adding IP routes for a 3GPP route and a non-3GPP route, wherein a metric value is assigned a value for each route.

19. The storage medium according to claim 11, further comprising, for the splitting mode of ATSSS, deploying a custom hash function and configuring the route to include multiple nexthops, wherein each nexthop is assigned a weight value, and wherein the custom hash function splits packets of a matched flow among different available paths based on the ATSSS policy.

20. The storage medium according to claim 11, further comprising, for the steering mode of ATSSS, using IP tables to mark user traffic and using IP rules to filter traffic based on DSCP and steer to multiple route tables.
